(19) United States
(12) Patent Application Publication
(10) Pub. No.: US 2010/0038446 A1
(43) Pub. Date: Feb. 18, 2010

(54) MULTIFUNCTION SHOWER HEAD

(75) Inventor: Maurizio Mora, Bollate (MI) (IT)

Correspondence Address: HESS PATENT LAW FIRM, P.C., 9 MIRAMAR LANE, STAMFORD, CT, 06902, US

(73) Assignee: SHOWER PRO S.r.l., Omegna (VB) (IT)

(21) Appl. No.: 12/534,831

(22) Filed: Aug. 3, 2009

(30) Foreign Application Priority Data
Aug. 18, 2008 (EP) 08425565.2

(51) Int. Cl. B05B 1/08

(52) U.S. Cl. 239/99

(57) ABSTRACT

A multifunction shower head (1) for the delivery of a liquid is described, this having a head portion (9) that includes at least one inlet port (2), at least one diffuser (30) having a plurality of outlet ports (3) arranged along at least one circumference and means (13, 14) that include at least one rotating shut-off device (14) to generate, upon command, a continuous jet or a pulsating jet through the plurality of outlet ports (3). The means (13, 14) and the plurality of outlet ports (3) are mutually movable in translation, in approach or moving apart, between a first position, in correspondence to which a continuous jet is delivered, and a second position in correspondence to which a pulsating jet is delivered.

### BACKGROUND OF THE INVENTION

The present invention concerns a multifunction shower head and, in particular, a shower head equipped with means to generate a continuous or pulsating jet through a plurality of outlet ports arranged along at least one circumference.

This type of shower head can be installed in a bathroom, in showers or baths for example, to create a massage effect on the user's body, or even in the kitchen, on the sink for example, to make washing up of dishes easier and more effective.

As is known in the art, the optional pulsating jet is generally produced by cyclically obstructing a plurality of peripheral outlet ports intended for this type of jet and separate from the peripheral ports intended to deliver a continuous jet, by means of a rotating element operated by the same flow of water that is delivered.

With respect to the delivery of a continuous jet from the peripheral outlet ports, in pulsating jet conditions, the delivery of liquid through each port varies cyclically from zero flow when the port is obstructed by the rotating element, to a flow of higher speed than that of the continuous jet when the outlet port is completely open and in fluidic communication with the outside.

The speed increase of the pulsating jets delivered through the free ports is due to the fact that, for the same pressure in the water supply circuit, one or more ports are obstructed and therefore the overall section of the free outlet ports is less.

Some known shower heads able to deliver a pulsating jet are described, for example, in U.S. Pat. No. 4,089,471 and No. 4,141,502, in which one or more choking elements of the peripheral outlet ports are set in rotation by the flow of water delivered.

In particular, U.S. Pat. No. 4,089,471 presents a shower head able to deliver, upon command, a stable condition with continuous jets or a stable condition with pulsating jets from separate peripheral outlet ports arranged along two different concentric circumferences.

Switching between the two types of jets, pulsating or continuous, entails movement of the entire unit for pulsating jet generation, the obstruction of flow through this unit and the simultaneous deviation of flow through a different crown of peripheral jets. The latter, obtained partially on the outer surface of the unit for pulsating jet generation and partially on the inner surface of the shower head, are defined in a precise manner only after switching from the condition of pulsating jets to the condition of continuous jets is completed.

U.S. Pat. No. 4,141,502 presents a shower head able to deliver different types of jets, amongst which also a continuous jet and a pulsating jet, following the rotation of the shower head with respect to the shower head body. The rotation of the shower head, as well as bringing the desired type of jets into the operative position, also causes deviation of the flow of water from the inlet port to the outlet ports of the delivery portion that finds itself in the operative condition.

In general, the known types of shower heads are particularly expensive and complex to manufacture and not very practical to use.

The available delivery functions are also limited, unless the mechanisms and the path of fluids inside the shower head are complicated even further or the overall dimensions of the shower head are increased.

### SUMMARY OF THE INVENTION

The object of the present invention is therefore that of providing a multifunction shower head that is both simple and economic to manufacture.

Another object of the present invention is that of providing a multifunction shower head that is particularly practical to use and that allows the switching between the various types of delivery available to be selected with a limited number of controls.

A further object of the present invention is that of providing a shower head able to make a larger number of delivery functions available with respect to known types of shower heads.

These and other objects are achieved by the present invention thanks to a multifunction shower head, which has a head portion that includes at least one inlet port, at least one diffuser having a plurality of outlet ports arranged along at least one circumference and means that include at least one rotating shut-off device to generate, upon command, a continuous jet or a pulsating jet through the plurality of outlet ports. The means for generating a continuous jet or a pulsating jet upon command and the plurality of outlet ports are mutually movable in translation, in approach or in moving apart, between a first position, in correspondence to which a continuous jet is delivered, and a second position in correspondence to which a pulsating jet is delivered.

In this way, it is possible to choose between the delivery of a pulsating jet and the delivery of a continuous jet through the same outlet ports, without the need to provide different outlet ports for the two types of jet.

According to a first embodiment of the present invention, the diffuser is fixed with respect to the head portion, while the rotating shut-off device is movable in translation in a direction parallel to its own axis of rotation between a position away from the outlet ports, in correspondence to which a continuous jet is delivered, and a position close to outlet ports, in correspondence to which the rotating shut-off device cyclically obstructs one or more of the outlet ports during its rotation to deliver a pulsating jet.

The outlet ports destined to deliver a continuous or pulsating jet are arranged along at least one circumference and constitute peripheral outlet ports that surround at least one central outlet port. The latter, concentric with the circumference along which the peripheral outlet ports are arranged, can be advantageously equipped with an aerator.

To deviate the delivery of liquid between the central outlet port and the peripheral outlet ports, a switching device is provided that can be manually operated via a switching button. To allow this switching function, the device includes at least one stem to which a diverter element is constrained and at least one return spring to maintain the position of the diverter element in the condition for delivery through the central outlet port as the default.

In addition to the rotating shut-off device, the means for generating a pulsating jet also comprise a drive element that includes at least one hole opportunely oriented to direct the flow of liquid in the direction of propulsion of the rotating shut-off device. The latter is slidingly constrained to the drive element, such that both of these components are movable in translation in a direction parallel to the axis of rotation of the rotating shut-off device.

The switching device advantageously also includes a thrust element and an elastically deformable member that are inserted between the switching button and the stem to which the diverter element is fixed.

In particular, the thrust element includes a central portion upon which a projection of the switching button acts by contact and a pair of side arms perpendicular to the central portion.

The elastically deformable member includes a central hub having a seat able to receive one end of the stem connected to the diverter element and a pair of radial tongues that basically constitute the elastically deformable part of the member. The free ends of the radial tongues are housed in respective hollow seats on the side arms of the thrust element.

To select pulsating jet or continuous jet delivery from the peripheral ports, the switching device also includes a pair of columns having one pair of ends housed in the hollow seats on the side arms of the thrust element and the opposite ends constrained by the drive element, thereby keeping the columns integral with the drive element in translation.

In this way, it is possible to operate the switching of the various types of delivery with a single button. For example, considering starting from the preset condition of delivery through the central jet, possibly equipped with an aerator, pressure on the switching button allows delivery of the liquid to be deviated from the central port to the peripheral ports, in the continuous delivery condition. This condition is steadily maintained during delivery by the same pressure of the delivered liquid.

To switch from the continuous jet condition to the pulsating jet condition through the peripheral ports, it is sufficient to exert and maintain further pressure on the same switching button.

Considering that, in the condition of continuous jet delivery through the peripheral outlet ports, the diverter element is against an end stop and therefore the stem that is integral with it can drop no further, additional pressure on the switching button causes bending of the tongues of the deformable member and therefore translated movement of the columns, the latter resting against tongues and also housed in the hollow seats of the arms of the thrust element.

The lowering of the columns consequently causes the lowering of the drive element and the rotating shut-off device mounted on it with a sliding engagement. The rotating shut-off device approaches the peripheral outlet ports, cyclically obstructing them during its rotation and thereby generating the desired pulsating jet. When the extra pressure exerted on the switching button is released, a pair of springs, opportunely positioned and constrained with respect to the columns, return the rotating shut-off device, the drive element and the same columns to the previous position and, in turn, the elastically deformable member returns to its original condition (not deformed).

It is therefore evident that, according to the invention, the switching of the type of delivery between three different types of available jet (central jet, continuous peripheral jet and pulsating peripheral jet) can be performed with a single button.

In one embodiment of the present invention, still further means of reset can be provided to return the diverter element from the position in which the liquid is delivered by the peripheral outlet ports to the position in which the liquid is delivered by the central outlet port. The means of reset are manually operated via a reset button, separate from the previously mentioned switching button.

In particular, the means of reset include a lever fitted with a fork at one of its ends, the bottom of which abuts against the elastically deformable member. The corresponding reset button includes a projecting portion able to exert force on the other end of the lever, so as to allow the manual operation of the lever in rotation around the respective fulcrum and so return the diverter element to the position in which delivery of the liquid is deviated to the central outlet port.

In another embodiment of the present invention, an auxiliary shut-off member could also be provided to temporarily interrupt the flow of liquid between the inlet port and the peripheral outlet ports. The auxiliary shut-off member can be manually operated via a break button acting directly on it.

According to a further embodiment of the present invention, the diffuser is movable in translation with respect to the head portion in a direction parallel to the axis of rotation of the rotating shut-off device. In this case as well, the translation is effected between a position away from the outlet ports, in correspondence to which a continuous jet is delivered, and a position close to outlet ports, in correspondence to which the rotating shut-off device cyclically obstructs one or more of the outlet ports during its rotation to deliver a pulsating jet.

The translation of the diffuser can be implemented, for example, by means of a manually operated ring nut, which is screw-engaged with the head portion and is integral in translation with the diffuser.

### BRIEF DESCRIPTION OF THE DRAWING

Further characteristics and advantages of the present invention will become evident from the following description, made by way of non-limitative example, with reference to the enclosed drawings, where:

FIG. 1 is an exploded view that shows some of the components of the shower head according to a possible embodiment of the present invention;

FIGS. 1A and 1B are enlarged section views of some of the components of the shower head according to the embodiment in FIG. 1;

FIG. 2 is a longitudinal section view of the complete shower head according to the embodiment shown in FIG. 1, with the diverter element arranged in the position for delivery through the central outlet port;

FIG. 3 is a longitudinal section view similar to that in FIG. 2, but with the diverter element arranged in the position for delivery through the peripheral outlet ports;

FIGS. 4A-4C are schematic cross-section views of the shower head along the IV-IV plane in FIG. 3, in different operating conditions; and

FIG. 5 is a schematic cross-section view that shows another possible embodiment of the present invention.

### DETAILED DESCRIPTION OF THE INVENTION

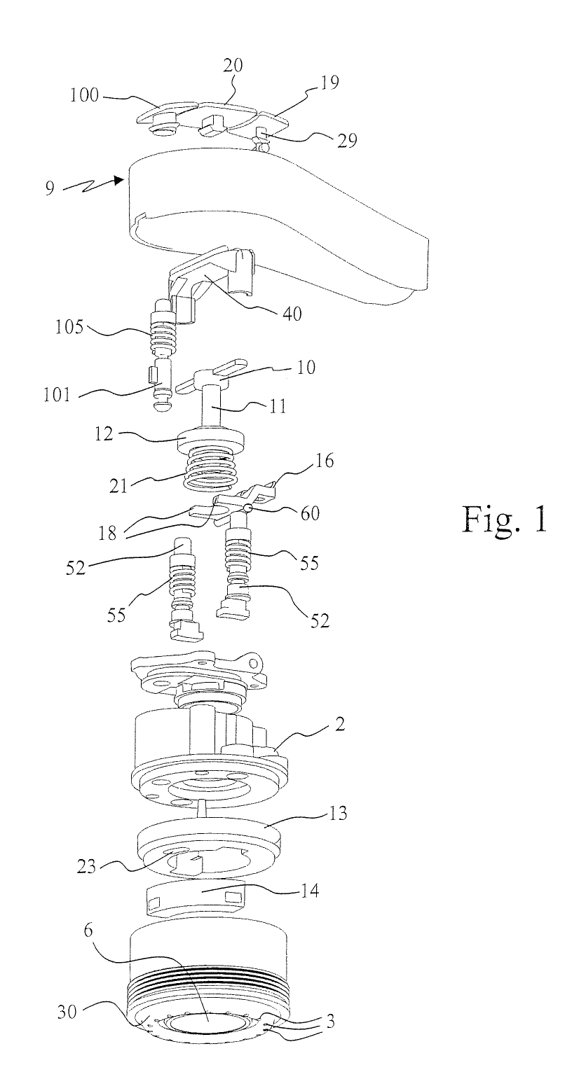

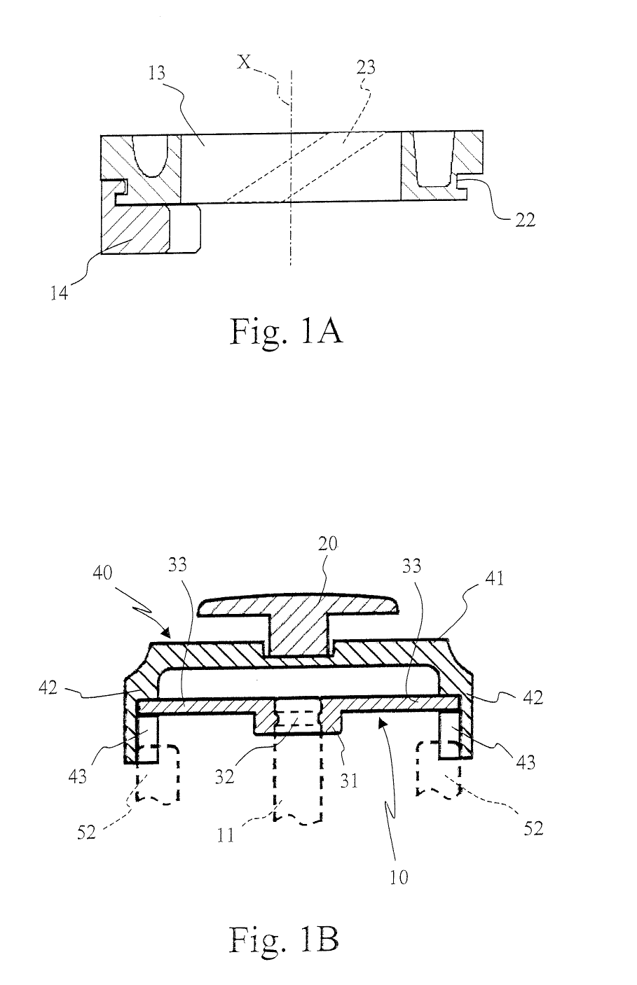

FIGS. 1, 1A, 1B, 2, 3 and 4A-4C show an embodiment of a shower head 1 suitable for kitchen use. The shower head 1 comprises an inlet port 2, a plurality of peripheral outlet ports 3 distributed “in a crown” along a circumference and a central outlet port 6 concentric with the circumference along which the peripheral outlet ports 3 are arranged.

To generate a pulsating jet through the outlet ports 3, at least one rotating shut-off device 14 and a drive element 13, which includes at least one hole 23 oriented so as to direct the flow of liquid in the direction of propulsion of the rotating shut-off device 14 and cause its rotation, are provided.

As is evident from FIG. 1A, the shut-off device 14 turns around axis X and is slidingly constrained to the drive element 13. The rotating shut-off device 14 is actually constrained in a sliding manner to the drive element 13 via a linear guide 22. Both components 13 and 14 are also movable in translation in a direction parallel to the axis of rotation X of the rotating shut-off device 14.

The unit comprising the rotating shut-off device 14 and the drive element 13 is movable in translation between a position away from the peripheral outlet ports 3, in correspondence to which a continuous jet is delivered, and a position close to peripheral outlet ports 3, in correspondence to which a pulsating jet is delivered from the peripheral ports 3.

In particular, when the rotating shut-off device 14 is in the position away from the peripheral outlet ports 3, liquid flows freely to the outlet ports 3. Instead, when the rotating shut-off device 14 approaches the peripheral outlet ports 3, the rotating shut-off device 14 cyclically obstructs one or more of the peripheral outlet ports during its rotation, thus causing the delivery of a pulsating jet through the peripheral outlet ports 3.

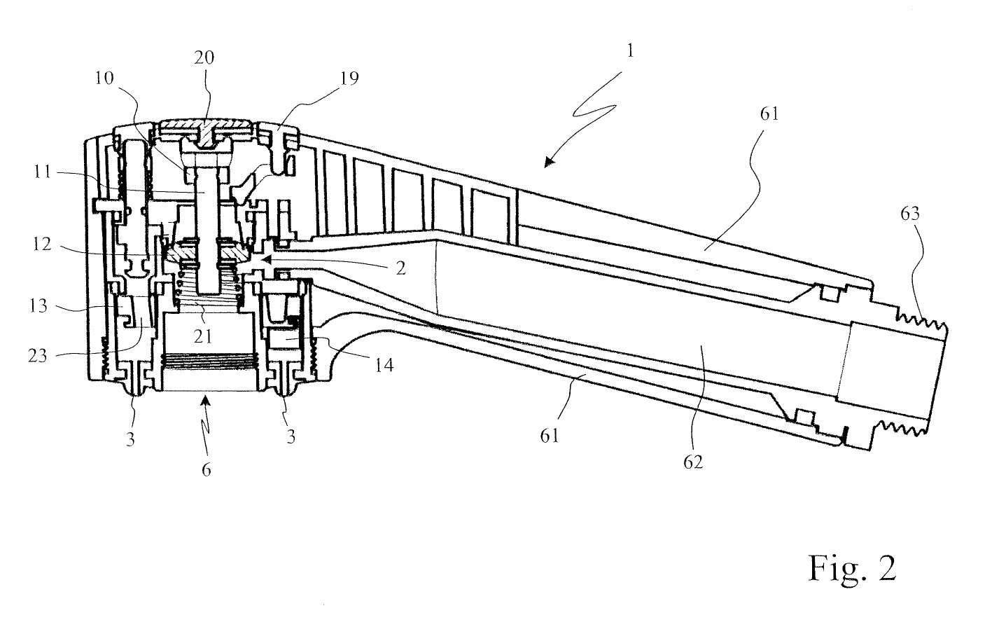

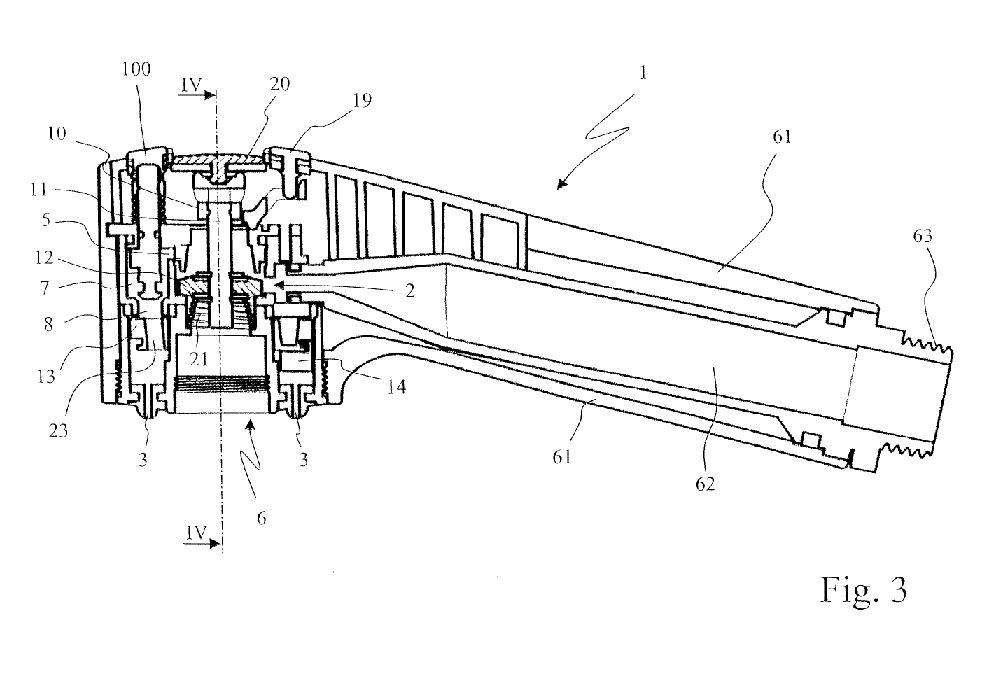

FIGS. 2 and 3 show a shower head 1 in section that includes a handgrip portion 61 inside which a feed tube 62 is inserted, which is equipped with a standard threaded connector 63 at its free end.

Selection of the desired jet on the shower head 1 is made by means of a switching device, manually operated via a switching button 20.

To deviate delivery of the liquid between the central outlet port 6 and the peripheral outlet ports 3, the switching device comprises a stem 11 to which a diverter element 12 is constrained, as is a return spring 21 to oppose the thrust exerted on the diverter element 12 following pressure applied to the switching button 20.

In FIG. 2, the diverter element 12 is in contact against the upper part of the seating in which it is housed and is kept firmly in this position by the spring 21. In this way, the liquid that enters from the inlet port 2 is routed directly to the central outlet port 6, generally fitted with an aerator (not shown).

Following pressure applied to the switching button 20, the diverter element 12 is brought into contact against the lower part of the seating in which it is housed (FIG. 3). The same pressure of the delivered liquid permits keeping the diverter element 12 in this position, overcoming the thrust exerted by the spring 21.

As is well known in the art, the modulus of elasticity of the spring 21 is opportunely chosen to obtain this effect and the return of the diverter element 12 to the position in FIG. 2 can be achieved automatically upon stopping the flow of liquid to the shower head, or manually as shall be explained in greater detail hereunder.

When the diverter element 12 is in the position indicated in FIG. 3, the liquid that enters from the inlet port 2 is routed above the diverter element 12, passes through a port 5 and enters in a chamber 7 placed in fluidic communication with the peripheral outlet ports 3, thereby creating the delivery of a continuous jet from them.

In the same condition, namely when the diverter element 12 is in the position in FIG. 3, it is also possible to obtain the delivery of a pulsating jet from the peripheral outlet ports 3 by acting on the same switching button 20.

To implement this function, the switching device also includes at least one thrust element 40 and at least one elastically deformable member 10 that are inserted between the switching button 20 and the stem 11 of the diverter element 12.

As shown in the enlarged view in FIG. 1B, the thrust element 40 includes a central portion 41 upon which a projection of the switching button 20 rests and a pair of side arms 42 perpendicular to the central portion 41. In turn, the elastically deformable member 10 includes a central hub 31 having a seat 32 in which an end of the stem 11 (shown with a dashed line) connected to the diverter element is engaged and retained, and a pair of elastically deformable radial tongues 33 with the free ends housed in respective hollow seats 43 of the side arms 42 of the thrust element 40.

The ends of the columns 52 (shown here with dashed lines) are also partially housed in the hollow seats 43 of the side arms 42 of the thrust element 40. In turn, the opposite ends of the columns 52 are constrained to the drive element 13 and integral with it in translation.

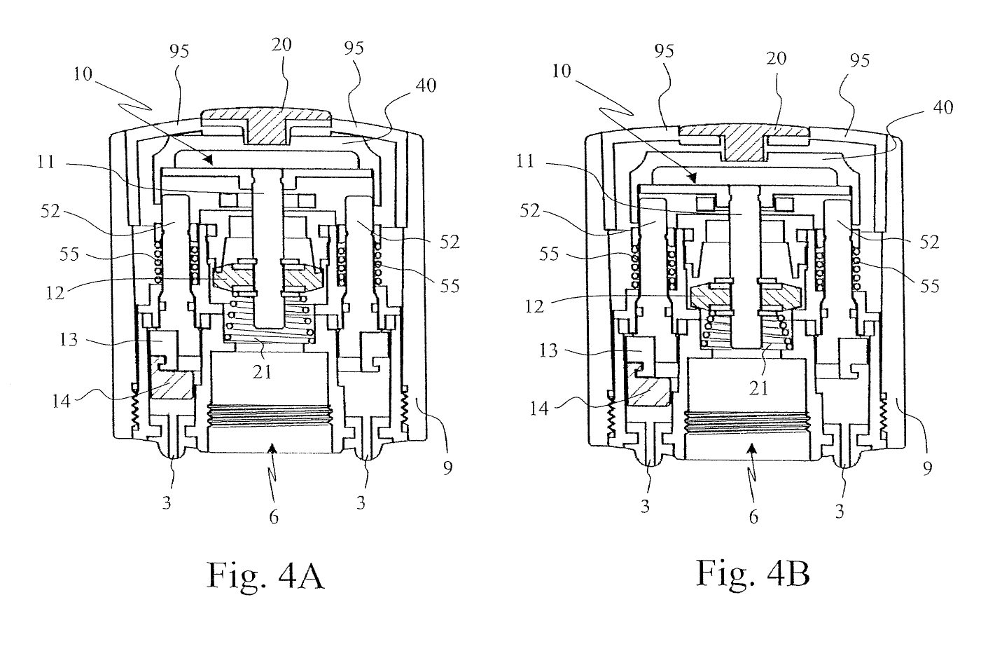

The same conditions of operation represented by the longitudinal sections in FIGS. 2 and 3 are also shown in cross section in FIGS. 4A and 4B respectively.

In addition to the positions that the switching device's components, such as 10, 12 and 40 for example, assume in these views, a covering cap 95 is also shown, which surrounds the button 20 and is inserted inside the head portion 9. The cap 95 is made of an elastically deformable material and its function shall become clear from the description that follows, with reference to FIG. 4C.

In fact, it is possible to apply further pressure on the switching button 20 to perform the temporary switching between continuous jets and pulsating jets.

In this case, the diverter element 12 is firmly in the same position shown in FIG. 4B and further pressure on the switching button 20 causes the elastic deformation of the cap 95 and the lowering of the thrust element 40. In turn, the latter, thanks to the fact that the stem 11 is blocked, causes the tongues 33 of the elastically deformable member 10 to bend, with the tongues 33 that after bending and making contact with the ends of the columns 52, start to push them downwards.

The downward movement of the columns 52 consequently causes movement of the drive element 13 and the rotating shut-off device 14 that is integral with it in translation. The rotating shut-off device 14 therefore approaches the peripheral outlet ports 3 and, due to the effect of the flow of fluid passing through the hole 23 of the drive element 13, the rotating shut-off device 14 is set in motion and cyclically obstructs the peripheral ports 3, thereby giving rise to the pulsating jet.

The moment in which the pressure applied by the user on the switching button 20 ceases, the deformable member 10 elastically returns to its initial condition (not deformed), while the rotating shut-off device 14, drive element 13 and columns 52 are moved away from the outlet holes by the return of the coil springs 55, thus returning to the condition of continuous jet delivery from the peripheral outlet ports 3.

In this way, operation of the switching button 20 not only allows switching the position of the diverter element 12 to select delivery from either the central port 6 or peripheral ports 3 (FIGS. 4A and 4B), but also allows selection of the type of jet, continuous or pulsating, delivered through the peripheral outlet ports 3 (FIG. 4C).

Referring again to FIG. 1, means of reset are also shown for returning the diverter element 12 from the position in which the liquid is delivered through the peripheral outlet ports 3 to the position in which the liquid is delivered through the central outlet port 6.

These means of reset, which are manually operated via a reset button 19, include a lever 16 fitted with a fork 18 at one end which abuts against the bottom of the elastically deformable member 10. The reset button 19 includes a projecting portion 29 that allows force to be exerted on the other end of the lever 16 to manually operate the lever around the associated fulcrum 60.

In the embodiment described here, an auxiliary shut-off member 101 to temporarily interrupt the flow of liquid between the inlet port 2 and the plurality of peripheral outlet ports 3 is also provided. The auxiliary shut-off member 101 is manually controlled via a break button 100 to block the path of the fluid through passage 8, visible in FIG. 3, when the diverter element 12 is in the position shown in FIG. 3 (or FIG. 4B), that is to say during delivery through the peripheral outlet ports 3. To restore delivery, a spring 105 (FIG. 1) is provided that returns the auxiliary shut-off member 101 to its inactive position.

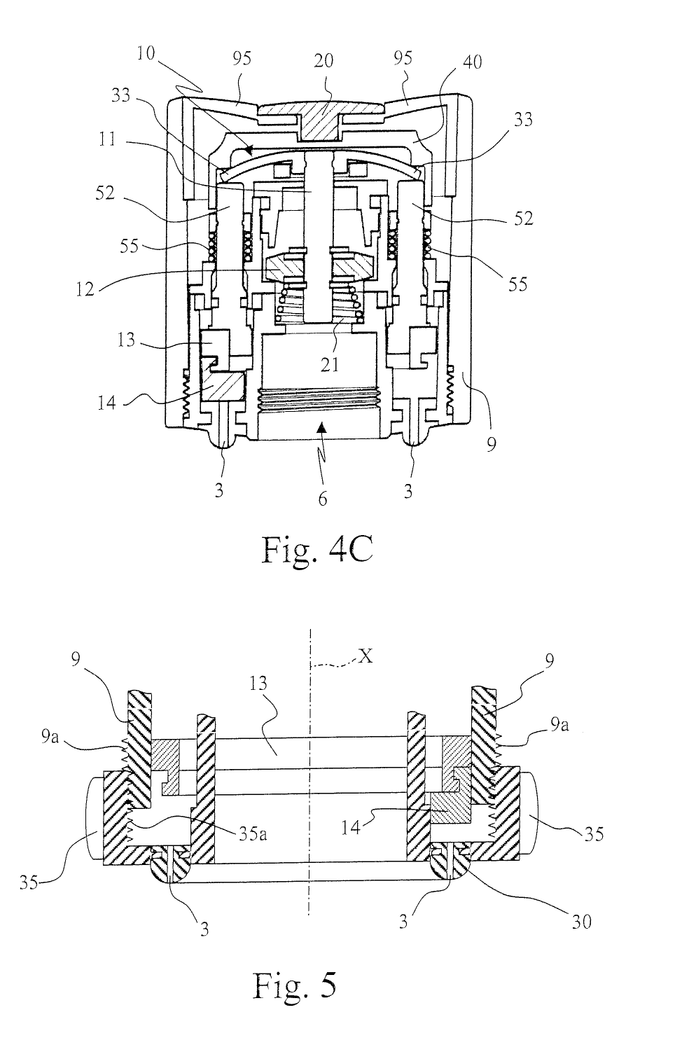

Now, referring to FIG. 5, another possible embodiment of the present invention is schematically shown that can also be suitable for bathroom shower heads.

In this embodiment, the diffuser 30 is movable in translation with respect to the head portion 9 in a direction parallel to the axis of rotation X of the rotating shut-off device 14. The movement can be achieved manually, for example, by acting on a ring nut 35, threaded on its internal surface 35a, which is screw-engaged on a corresponding external threaded surface 9a of the head portion 9.

When the ring nut 35 is screwed, the outlet ports 3 approach the rotating shut-off device 14 until the position is reached in correspondence to which the rotating shut-off device 14 cyclically obstructs one or more of the outlet ports during its rotation, so as to deliver a pulsating jet through the same outlet ports 3.

When the ring nut 35 is unscrewed, the diffuser 30 moves away from the rotating shut-off device 14 and the outlet ports 3 are no longer obstructed by it. Once a distance sufficiently apart from the rotating shut-off device 14 and the outlet ports 3 is reached, a continuous jet from the same outlet ports 3 is then delivered.

In this embodiment, the central outlet port can also be absent or possibly substituted by a plurality of ports distributed along lines concentric with the peripheral ports 3 and arranged more to the outside or the inside with respect to the latter.

The two embodiments explained herein for achieving the relative movement in translation between the rotating shut-off device 14 and the diffuser 30 can also coexist in the same shower head, independently of whether it is destined to kitchen or bathroom applications.

What is claimed is:

1. A multifunction shower head (1) for the delivery of a liquid having a head portion (9) that includes at least one inlet port (2), at least one diffuser (30) having a plurality of outlet ports (3) arranged along at least one circumference, and means (13, 14) that include at least one rotating shut-off device (14) to generate, upon command, a continuous jet or a pulsating jet through said plurality of outlet ports (3), characterized in that said means (13, 14) and said plurality of outlet ports (3) are mutually movable in translation between a first position in correspondence to which a continuous jet is delivered and a second position in correspondence to which a pulsating jet is delivered.

2. The shower head according to claim 1, wherein said diffuser (30) is fixed with respect to said head portion (9), and wherein said rotating shut-off device (14) is movable in translation in a direction parallel to its own axis of rotation between a position away from said outlet ports (3), in correspondence to which a continuous jet is delivered, and a position close to said outlet ports, in correspondence to which said rotating shut-off device (14) cyclically obstructs one or more of said outlet ports during its rotation to deliver a pulsating jet.

3. The shower head according to claim 1, wherein said plurality of outlet ports (3) arranged along at least one circumference are peripheral outlet ports that surround at least one central outlet port (6) concentric with said at least one circumference along which said peripheral outlet ports (3) are arranged.

4. The shower head according to claim 3, wherein a switching device (10, 11, 12, 21, 40, 52) is provided that is manually operated via a switching button (20) to deviate delivery of the liquid between said central outlet port (6) and said peripheral outlet ports (3).

5. The shower head according to claim 4, wherein said switching device (10, 11, 12, 21, 40, 52) includes a stem (11) to which a diverter element (12) is constrained and at least one return spring (21) to oppose the thrust exerted on said diverter element (12) following pressure applied on said switching button (20).

6. The shower head according to claim 1, wherein said means (13, 14) for generating a pulsating jet further comprise a drive element (13) that includes at least one hole (23) to direct the flow in the direction of propulsion of said rotating shut-off device.

7. The shower head according to claim 6, wherein said rotating shut-off device (14) is slidingly constrained to said drive element (13), and wherein both are movable in translation in a direction parallel to the axis of rotation of said rotating shut-off device.

8. The shower head according to claim 5, wherein said switching device (10, 11, 12, 21, 40, 52) also includes at least one thrust element (40) and at least one elastically deformable member (10) inserted between said switching button (20) and said stem (11).

9. The shower head according to claim 8, wherein said thrust element (40) includes a central portion upon which a projection of said switching button (20) rests and a pair of side arms perpendicular to said central portion, and wherein said elastically deformable member (10) includes a central hub having a seat able to receive an end of the stem (11) connected to the diverter element (12), and a pair of elastically deformable radial tongues having their respective ends housed in respective hollow seats on the side arms of said thrust element (40).

10. The shower head according to claim 9, wherein said switching device (10, 11, 12, 21, 40, 52) further includes a pair of columns (52) having one pair of ends housed in said hollow seats on the side arms of said thrust element (40) and the opposite ends constrained to said drive element (13) and integral in translation with said drive element (13).

11. The shower head according to claim 5, wherein means of reset (16, 17, 18) are provided that can be manually operated via a reset button (19) to return said diverter element (12) from the position in which the liquid is delivered by said peripheral outlet ports (3) to the position in which the liquid is delivered by said central outlet port (6).

12. The shower head according to claim 11, wherein said means of reset (16, 17, 18) include a lever (16) fitted at one end (17) with a fork (18) having the bottom which abuts against said elastically deformable member (10), said reset button (19) including a projecting portion to exert force on the other end of said lever (16) to manually operate the rotation of said lever around its fulcrum (60).

13. The shower head according to claim 1, wherein an auxiliary shut-off member (101) is provided that can be manually operated via a stop button (100) to temporarily interrupt, upon command, the flow of liquid between said at least one inlet port (2) and said plurality of outlet ports (3) arranged along at least one circumference.

14. The shower head according to claim 1, wherein said diffuser (30) is movable in translation with respect to said head portion (9) in a direction parallel to the axis of rotation of said rotating shut-off device (14) between a position away from said outlet ports (3), in correspondence to which a continuous jet is delivered, and a position close to said outlet ports, in correspondence to which said rotating shut-off device (14) cyclically obstructs one or more of said outlet ports during its rotation to deliver a pulsating jet.

15. The shower head according to claim 14, wherein at least one ring nut (35) is provided that is screw engaged to the head portion (9) of the shower head (1) and is integral in translation with said diffuser (30).
